(19) United States
(12) Patent Application Publication
(10) Pub. No.: US 2006/0251327 A1
(43) Pub. Date: Nov. 9, 2006

(54) Light invariant face recognition

(76) Inventors: Miroslav Trajkovic, CORAM, NY (US); Srinivas Guita, Eindhoven (NL); Vasanth Philomin, Stolberg (DE)

Correspondence Address: PHILIPS INTELLECTUAL PROPERTY & STANDARDS, P.O. BOX 3001, BRIARCLIFF MANOR, NY, 10510, US

(21) Appl. No.: 10/539,692

(22) PCT Filed: Dec. 17, 2003
(86) PCT No.: PCT/IB03/06108

§ 371 Date: Jun. 16, 2005

Related U.S. Application Data
(60) Provisional application No. 60/435,247, filed on Dec. 20, 2002.

(51) Int. Cl. G06K 9/62

(52) U.S. Cl. 382/209

(57) ABSTRACT

Random sample subsets are selected from an image. The RANSAC algorithm is used to perform robust matching between the samples of a captured image and like samples of stored images. By selecting enough samples the likelihood that all samples will be affected by lighting changes is less and therefore it is more likely that a match will be found even in the case of different lighting in the captured image than the stored images. Additionally a weighted sampling technique is used which selects samples based on likelihood of being affected by lighting changes.

### FIELD OF THE INVENTION

This invention relates in general to face recognition and in particular to light invariant face recognition.

### BACKGROUND OF THE INVENTION

Face recognition systems are used for the identification and verification of individuals for many different applications such as gaining entry to facilities, recognition of people to personalize services such as in a home network environment, and locating wanted individuals in public facilities. The ultimate goal in the design of any face recognition system is to achieve the best possible classification (predictive) performance. Depending on the use of the face recognition system it may be more or less important to make sure that the comparison has a high degree of accuracy. In a high security application such as identifying wanted individuals, it is very important that identification is achieved regardless of minor changes in the captured image vs. the stored image.

The process of face recognition typically requires the capture of an image, or multiple images, of a person, processing the image or images and then comparing the image with stored images. If there is a positive match between the stored image and the captured image the identity of the individual can either be found or verified. U.S. Pat. No. 6,292,575 describes such a system and is hereby incorporated by reference.

The processing of the images includes normalization. Normalization insures that the size of the face in the captured image is relatively the same size as in the stored images. This normalization is an attempt at controlling differences that might occur in a captured image which are not found in a stored image (and visa-versa). These differences cause false negative identification results when the two faces are compared but when in actuality the same person appears in both images.

Many systems also control the lighting of the captured image to insure that the lighting will be similar to the lighting of the stored images. Once the individual is positioned properly the camera takes a single or multiple pictures of the person and a comparison is made to stored pictures. A problem with these systems is that for many applications, such as for security applications, sometimes the lighting of the captured image is different than the lighting used for the stored image. When the lighting is different in the captured image than the lighting in the stored image there is a chance a false negative identification result. Since it is not always possible to have the same lighting, a system is needed which will take into account the different lighting.

### SUMMARY OF THE INVENTION

Accordingly, it is an object of the invention to provide a system that performs face identification/verification which is less susceptible to errors caused by light variation.

This object is achieved by taking random samples of pixels within the face and performing comparisons with the same random samples in the stored images. The comparison is performed using almost any form of face recognition. The RANSAC algorithm is used to perform robust matching. The RANSAC algorithm helps eliminate the possibility of having shadowed regions of the face causing false negative results.

In one embodiment of the invention instead of a purely random sampling, a weighted sampling is used which is weighted in the areas of the face which are least likely to be affected by lighting. A determination is made as to which areas of the face are more likely to be affected by lighting. The samplings are then weighted in the areas where there is a lower probability of light changes. These weighted samples are then compared to the like pixels in the stored images using face recognition to determine similarity.

Other objects and advantages will be obvious in light of the specification and claims.

### BRIEF DESCRIPTION OF THE DRAWINGS

For a better understanding of the invention reference is made to the following drawings:

FIG. 1a shows the selection of a line through a set of points in the presence of outliers.

FIG. 1b shows the selection of a line through a set of points in the presence of outliers using the RANSAC algorithm.

FIG. 2 shows a flow chart of a preferred embodiment which uses the RANSAC algorithm to perform robust face recognition.

FIG. 3a shows images of random pixel samples of size 1000, for an image of size 64×72.

FIG. 3b shows random pixel samples for real images of size 133×100, and the random sample being 40% of the image.

FIG. 4 shows a flow chart of how weighted sampling is used in an exemplary embodiment of the invention.

FIG. 5 shows a security system in accordance with a preferred embodiment of the invention.

### DETAILED DESCRIPTION OF THE PREFERRED EMBODIMENTS

In typical face recognition programs pixels of a captured image are compared to pixels of stored images using face recognition methods. If a certain percentage of pixels match the same pixels in a stored image, the images are deemed to match and a verification or identification has occurred. There are many known face recognition methods which determine similarity between images. The term “match” as used herein can mean a probability of a match, an exact match, or enough pixels match above a predetermined threshold that identification is probable, or the similarity index found after performing face recognition on these samples is above a certain threshold. The problem is that if a portion of the face in the captured image has a shadow from a light source, and the image of this person in the stored database is shadow-free, when the pixels of the two images are compared it is likely that those pixels within the shadow will not match the corresponding pixels in the stored image. This is because there will be a large percentage of non-matching pixels due to uneven lighting rather than due to the faces in the images being from different people. If a certain percentage of pixels must match to be deemed a proper identification, the large percentage of non-matching pixels will cause a false negative match.

It has been found that face recognition can be performed on portions of a face rather than an entire face. The present invention chooses random samples of pixels within the face but these random samples are chosen as part of an algorithm which ignores “outliers”, i.e. data points that lie outside of a majority of the data points. The RANSAC algorithm is a robust estimation algorithm that avoids “outliers” from the chosen samples from causing incorrect matching results and it is used in a preferred embodiment of the instant invention. Other such algorithms can also be used such as the least median of squares (LmedS). The RANSAC algorithm, as explained below in more detail, chooses pixels randomly and detects “outliers” which in the present invention are the shadowed regions.

In a preferred embodiment of the invention the captured image is compared to the stored images using a known face recognition algorithm and if no match is found, then the captured image is randomly sampled and the random sample of pixels Tⱼ is compared to the same random sample in the stored images using a face recognition algorithm. The number of random samples selected is determined by the computing power and the degree of accuracy that is needed for a particular application. In a preferred embodiment, anywhere from 100 to 1000 or more sets of samples are chosen. Face recognition is performed on all samples. The sample that provides the best result (i.e. the sample that most closely matches the same sample in a stored image) is chosen and the result of the sample comparison is compared to a threshold. If the sample of the captured image matches the same sample in a stored image then the stored image is deemed to show the same person as in the captured image. The stored image that provides this match has a higher probability of being the same face as in the captured image since it is likely that one of the samples will be relatively free of outliers. This results in fewer false negatives since the random sample is less likely to include the portions of the face that are affected by lighting.

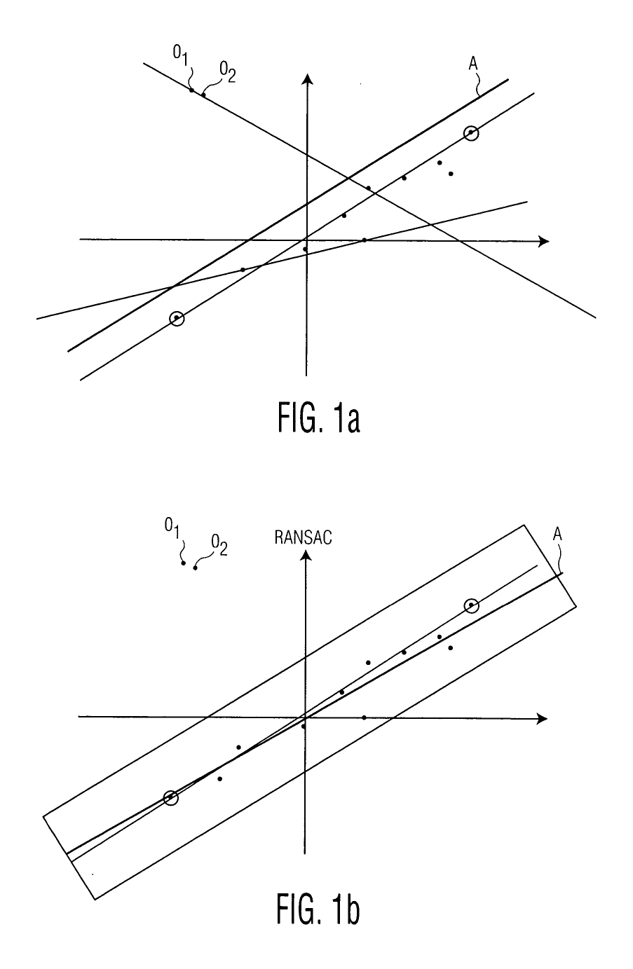

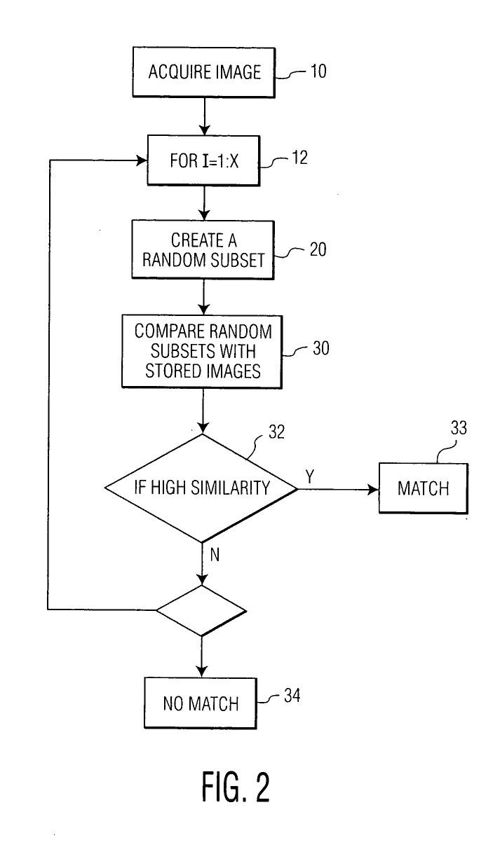

FIG. 2 shows a flow chart of a preferred method of this invention. At 10 an image is acquired. At 12, for I=1:X a random sample subset 20 is created. I is an increment and X is determined based on computing power and degree of accuracy needed. The RANSAC algorithm is used to select the subset and the number of subsets. RANSAC stands for Random Sample Consensus and it will be explained herein in terms of line estimation. It works similarly in other cases such as in images. Assume that a random sample of points exists as shown in FIG. 1a, and a line A must be fitted through these points. If there are outliers (there are two O₁ and O₂ in FIG. 1a, in the northwest quadrant) the line A will be significantly shifted from the true position. FIG. 1b shows this same random sample of points, but the line A is fitted using the RANSAC algorithm. In FIG. 1b the line A is a better line estimation than FIG. 1b if we assume that O₁ and O₂ are erroneous data points. RANSAC works the following way:
1. Randomly pick a minimal number of points needed to estimate the line (two).
2. Fit the line through these points.
3. Count the number of points from the set that are close to the line (according to a given criteria, i.e. all the points that are closer than three pixels are OK—they support the model.) Denote the number Nⱼ, which quantitatively represents the concentration of points near the line.
4. Repeat steps 1-3 enough times to ensure with a certain probability (usually 95-99%) that at least the two points that have been selected are a good representation of a concentration of the points.
5. Find the greatest of all Nⱼ and the line that has produced this Nⱼ. Using all Nⱼ points that support this line, estimate the optimal line using ordinary least squares method.

To perform general random sampling of pixels in an image, we represent an image as a vector, i.e., each pixel is assigned a unique number as shown in Table 1.

TABLE 1
Pixel annotation for a 64 x 72 image.

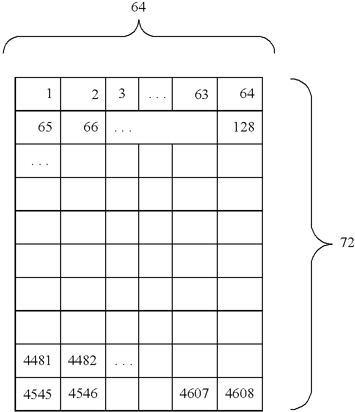

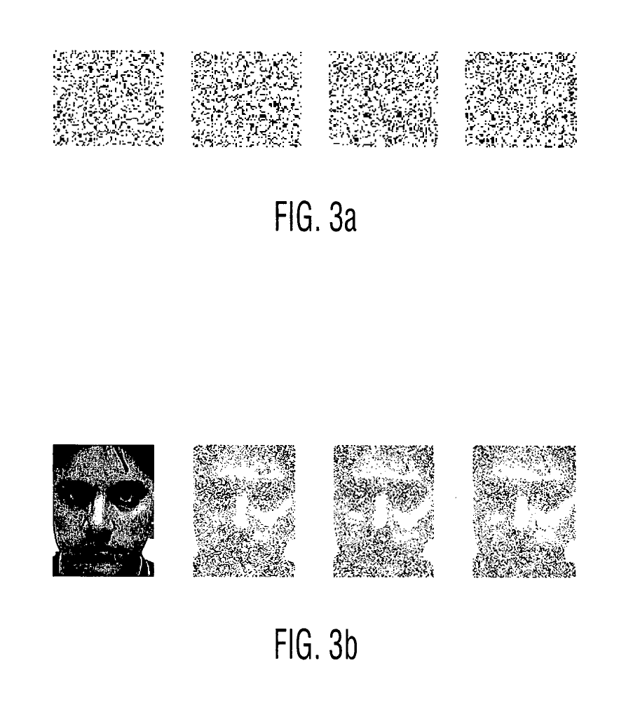

For the example given in Table 1, to create a sample of 100 random pixels we create a sample of random numbers between 1 and 4616, and then just choose pixels corresponding tot he 100 random numbers. FIG. 3a shows images of random samples of size 1000, for an image of size 64×72. FIG. 3b shows random pixel samples for real images of size 133×100, and the random sample being 40% of the image. There is a wide majority of algorithms to create random numbers available in any programming language (C/C++, Fortran) or programming package (MATLAB, Mathematica, etc).

In a preferred embodiment of the present invention, random sampling is used in the form of RANSAC which is applied to perform face recognition as follows:
1. Randomly pick a certain number of pixels from a facial test image (Tⱼ).
2. Compare Tⱼ with the corresponding (location-wise) pixels of the face in the database and compute a similarity measure sⱼ. (Note that sⱼ corresponds to Nⱼ in original RANSAC algorithm.)
3. Repeat steps 1-2 enough times X to ensure with a certain probability (usually 95-99%) that all of the sample points are not significantly affected by light changes. X can be estimated experimentally or computed as follows:

Assume that the facial image in question is formed of 1000 pixels and that 50 of them are affected by light changes. Further assume that only 100 facial pixels 10 can be selected to perform face recognition. If all 100 pixels are from the 950 pixels that are not affected by light changes, then there should be good recognition results. The probability that none of the selected 100 pixels are affected by light changes is given by

$$p = \frac{( \begin{matrix}950 \\ 100\end{matrix} )}{( \frac{1000}{100} )} = 0.0044758$$

If it is necessary to guarantee that at least one sample is outlier free with the probability of 0.99, then the number of samples X that needs to be chosen can be obtained from

$${( 1 - p )}^{X} < .01 ⇒ X \geq \frac{ln 0.01}{ln ( 1 - p )} = 1027$$

4. The measure of similarity is now obtained as s=max (sⱼ).
5. If s is above some given threshold, then we have a match, otherwise there is no match.

As explained above, the sets of regions are chosen randomly; for a large enough X it is likely that at least one set of regions will have consistent lighting that will match well with the corresponding set of regions in the database. If there is a high similarity, then there is a match between the captured image and the stored image with high similarity.

Referring back to FIG. 2. after the image is acquired at 10, then for X=1 to 1000 a random sample subsets (20) are chosen. For each sample, face recognition is performed on the sample by comparing using the RANSAC or other outlier detection algorithm, the sample of the captured image with the same random samples in the stored images at 30. If there is a high similarity 32 between the two samples then assume a match 33 between faces. Store the subset with the highest number of matches and determine if the number is high enough to declare a match between the images. If not then there is no match 34. In a first embodiment the face recognition is performed until a match is found or until X is reached. In a second embodiment, all samples are compared and the sample with the highest similarity is compared to a threshold to determine if there is a match.

Weighted Sampling for Light Invariant Recognition

While in uniform sampling all the pixels have the same probability of being chosen, in weighted sampling, some pixels are more likely to be chosen than the others. Weighted sampling has also been studied extensively in literature, and we will explain the difference between it and uniform sampling through the following example.

Let us assume that we need to choose one number between 1 and 5 (array X), but that sampling is not uniform but weighted, as shown in Table 2.

TABLE 2

| | X | | | | |
|---|---|---|---|---|---|
| | 1 | 2 | 3 | 4 | 5 |
| Weights | .1 | .2 | .3 | .2 | .2 |

One way to perform weighted sampling using the weights set forth in Table 2 would be to form an auxiliary array Y={1,2,2,3,3,3,4,4,5,5}

This array has 10 elements and, if uniform sampling is performed on the array Y it is equivalent to a weighted sampling of X. In this example, 2 is two times as likely to occur as 1; and 3 is most likely to occur with the probability of 0.3.

Weighted sampling for light-invariant face recognition is simply an extension of the use of the RANSAC algorithm in face recognition. In the previous case, sampling is performed uniformly, i.e. each pixel of the set Tⱼ is chosen with equal probability 1/(# of pixels in the face). In weighted sampling some pixels are more likely to be chosen than the others based on the following criteria.

Assume there is a face that has been photographed for 100 different illuminations.

Compare each pixel pⱼ in the original facial image (i.e. with uniform illumination) with the same pixel in the images obtained under different illuminations and count how many times the difference between them is below some given threshold. Let us denote this number nⱼ, and let

$$N = {\sum }_{j} {n}_{j}$$

The pixels with higher nⱼ are more useful as they are less likely to be affected by illumination changes, so these pixels result in higher accuracy if they are part of the comparisons. In other words, using these pixels one is more likely to find a comparison that is illumination invariant. Accordingly in the weighted-sampling embodiment of this invention, these “light invariant pixels” are chosen more frequently as part of Tⱼ. The probability of a pixel being selected in the weighted sample is not uniform but is given by the formula

$$prob ( j ) = \frac{{n}_{j}}{N}$$

The algorithm now proceeds the same way as with the RANSAC illumination invariant recognition described before.

Alternatively, to compute weights for sampling, computer graphics can be used. A 3D model of a head is created with light sources placed in different directions. Many computer graphics packages can then turn the 3d image back into 2 dimensions with the different light sources creating different effects on the 2 dimensional images. One can then determine which areas of the face have a higher likelihood of changing with different light sources. The portions of the face that have a low likelihood of changing can then receive a higher weight or a higher probability of being chosen than the pixels with a high likelihood of changing. Examples of programs that perform this type of ray tracing are POV-Ray, or OpenGL.

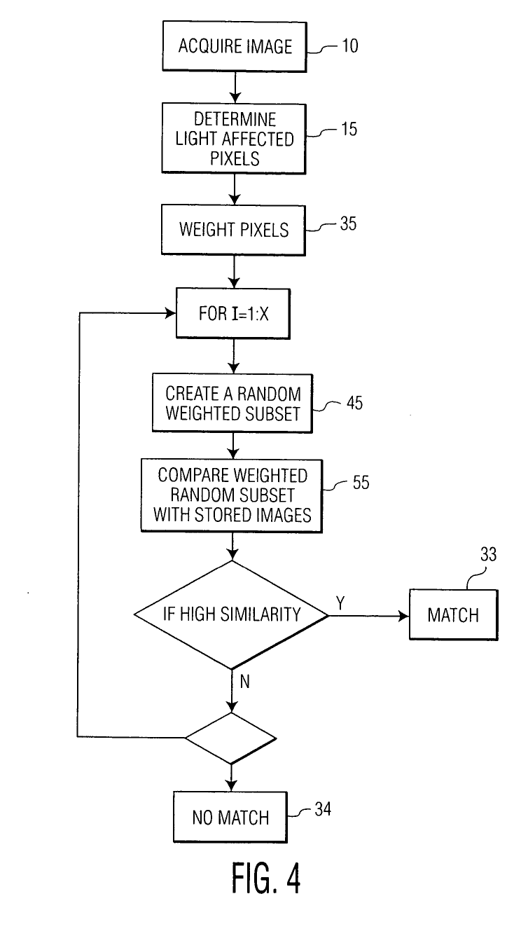

FIG. 4 shows a flow chart of a method of this invention where a weighted sampling is used. In this case an image is acquired at 10. The portions of the image most affected by light are determined at 15. The pixels are then weighted at 35 in favor of the light invariant pixels. At 12, for I=1:X a weighted sample subset is chosen at 45. At 55 the weighted subset is compared using same form of face recognition with the same weighted sample of the stored image. A probability of a match is then determined based on the subset with the best result.

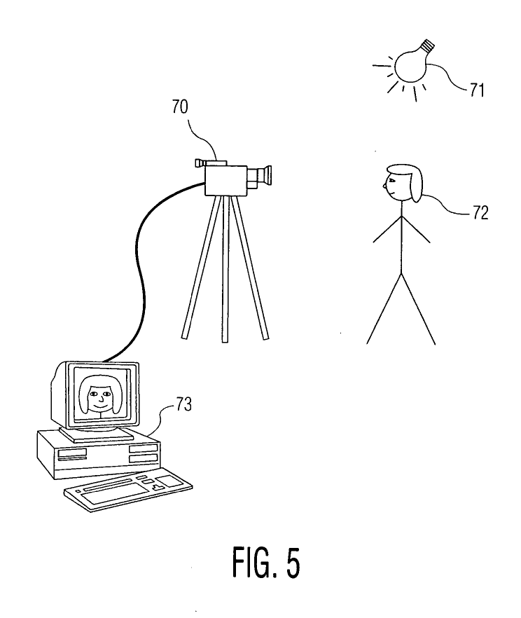

FIG. 5 shows a security application in accordance with the instant invention. An image is captured by an imaging device 70 of a person 72 walking into a room with an overhead light source 71. The image is compared to images stored in computer 73 in accordance with the invention.

While there has been shown and described what is considered to be preferred embodiments of the invention, it will, of course, be understood that various modification and changes in form or detail could readily be made without departing from the spirit of the invention. It is therefore intended that the invention be not limited to the exact forms described and illustrated, but should be constructed to cover all modifications that may fall within the scope of the appended claims.

1. A method of comparing a captured image to stored images to find a match, comprising:
retrieving a captured image;
setting default similarity index;
for I=1 to X,
take a random sample of pixels of the captured image;
perform face recognition between the random sample of the pixels of the captured image to corresponding random samples of pixels of the stored images;
calculate a new similarity index for the random sample of the captured image and replace the similarity index if new similarity index is higher;
increment I; and
determine if the similarity index is above a predetermined threshold for a match.

2. The method as claimed in claim 1, wherein a robust algorithm is used which samples the image and performs face recognition by substantially removing outliers from having an impact on the comparison results.

3. The method as claimed in claim 2, wherein the algorithm is the RANSAC algorithm.

4. The method as claimed in claim 2, wherein the algorithm is the least medium of squares algorithm.

5. The method is accordance with claim 1, wherein a weighted sample is used which is weighted with pixels which have a low likelihood of being affected by light.

6. The method in accordance with claim 1, wherein the step of determining occurs before the step of incrementing I, and if there is a match then additional random samples do not need to be taken and compared.

7. The method in accordance with claim 1, wherein the value of X is based on desired accuracy.

8. The method in accordance with claim 1, wherein the value of X is based on computing requirements.

9. A device for comparing a captured image to stored images to find a match, comprising:
a device which receives a captured image;
a processor which performs the following function:
create default similarity index;
For I=1 to X,
random sample the pixels of the captured image;
perform face recognition between the random sample of pixels of the captured image and the corresponding random sample of pixels of the stored images;
calculate a new similarity index and replace similarity index with new similarity index if it is higher; and
increment I;
determine if the similarity index is above a threshold for a match.

10. The device as claimed in claim 9, wherein the processor performs image comparison using an algorithm that substantially lessens the possibility that outliers will cause inaccurate results.

11. The device as claimed in claim 10, wherein the algorithm is the RANSAC algorithm.

12. The device as claimed in claim 10, wherein the algorithm is the least medium of squares algorithm.

13. The device as claimed in claim 9, wherein a weighted random sample is used which is weighted with pixels which have a low likelihood of being affected by light.

14. The device as claimed in claim 9, wherein the determining occurs before the step of incrementing I, and if there is a match then additional random samples do not need to be taken.

15. The device as claimed in claim 9, where the value of X is based on computing power.

16. The device as claimed in claim 9, where the value of X is based on desired accuracy.

17. A device for comparing images, comprising
a random sampler for selecting a plurality of random samples of pixels from a captured image;
a comparator that performs face recognition on the random sample and on a corresponding random sample in a stored image such that shadow regions of the random samples are treated as outliers and do not substantially affect the outcome of the face recognition;
a processor that computes a similarity index and determines if there is a match between the captured image and the stored image.

18. The device as claimed in claim 17, wherein a plurality of random samples are chosen and compared and the random sample with the highest similarity index is used to determine if there is a match between the captured image and the stored image.

19. A method of comparing images, comprising:
selecting a random sample of pixels from a captured image using a robust sampling algorithm;
performing face recognition, using this algorithm which substantially ignores shadowed regions of the image, on the random sample and the same random sample in a stored image;
computing a similarity index using this algorithm and determining if there is a match between the captured image and the stored image.

20. The method as claimed in claim 19 wherein the step of selecting selects a plurality of random samples and the step of performing face recognition compares the plurality of random samples with the same random samples in the stored images and computes similarity indexes and the highest similarity index is used to determine if there is a match between the captured image and the stored image.
